(19) United States
(12) Patent Application Publication
(10) Pub. No.: US 2004/0117835 A1
(43) Pub. Date: Jun. 17, 2004

(54) Digital home control system

(76) Inventor: Joseph Ernest Lorkovic, Carlsbad, CA (US)

Correspondence Address: Joseph Lorkovic, 2441 Torrejon Place, Carlsbad, CA, 92009, US

(21) Appl. No.: 10/669,232

(22) Filed: Sep. 22, 2003

Related U.S. Application Data
(60) Provisional application No. 60/413,304, filed on Sep. 24, 2002.

(51) Int. Cl. H04N 7/173; H04N 7/16; H04N 7/18; H04N 7/00

(52) U.S. Cl. 725/81; 348/552; 725/133; 725/141

(57) ABSTRACT

The system is dependent on an HTPC/PC with dual video output. It is a remote control and display for input and output. To the user this provides the essence of a portable computer but is in fact only a remote control. Video outputs are controlled so from the remote unit displays maybe exchanged. The HTPC system is to have a large display for viewing of movies. The remote control provides the small and close up display for other content. The computer remote control system includes an external wireless transceiver connected to the computer that provides communications between the computer and the portable remote control device. The portable remote control device includes a graphics display panel with a switch to swap the attached displays, wireless transceiver, keypad, pointing device, and universal serial buss port.

### CROSS-REFERENCE TO RELATED APPLICATIONS

THIS APPLICATION CLAIMS THE BENEFIT OF PROVISIONAL PATENT APPLICATION SER. No. 60/413,304 FILED Sep. 24, 2002

### FEDERALLY SPONSORED RESEARCH

Not Applicable

### SEQUENCE LISTING OR PROGRAM

Not Applicable

### FIELD OF INVENTION

The present invention is generally related to home entertainment, interactive communications systems, remote control of devices and, in particular, to a home theater personal computer system (HTPC) or set-top-box that may, in turn, be coupled to local area, wide area, cable, and terrestrial networks in support of communications and interactive broadcast television media in the forms of high definition, digital and analog.

### BACKGROUND ART

During the past years, there has been a substantial interest in developing a new class of computer device known as a home network appliance. Electronics manufactures and computer manufactures have not found a way to deliver the content from the computer and the Internet in harmony with television content in regard to a device in the home. The ideal device combines the new interactive media with the old and delivers on the promise of the “Digital Home” in a way that is affordable and comfortable for the consumer to adapt to. Throughout these years makers of computers and traditional home electronics have presented consumers with inadequate products. The current state of existing inventions purpose ways to implement wireless video. The concept of wireless video alone is an obvious and general byproduct of the technologies available to transmit wireless data that have been recently developed. The present invention concerns a viable implementation of wireless video and other components to provide a very practical product.

Most consumers want devices they are comfortable with and are fully functional in regard to gracefully merging the new media with the legacy media. At this time, for many consumers price is an important factor. The ideal device would be one that provided for all media types and would fill the roll of the computer and the home entertainment system/home theater. If the described device also provided for easy and inexpensive upgrade options and interoperability with the widest selection of peripheral devices it would be appealing. The obvious choice is the PC as adapted to the home theater known as “HTPC” or Home Theater Personal Computer. For clarification I define the HTPC systems as a standard Personal Computer with a generally large display and TV tuner. Beyond the above the HTPC is generally placed in the living room of a home in the home entertainment center. As implemented thus far the HTPC device has serious flaws that make it awkward to use and a wasteful implementation of computer resources. The first flaw is that if you purchase such a device it doesn't eliminate your need for a PC. The HTPC computing abilities are less useful because in most homes it would disrupt other forms of media being played such as a movie being watched by a group. Beyond that many applications are awkward to use when displayed on a large screen across the room.

Other available devices are proprietary and very limited. These include set top box and game box variants. These devices provide some form of use such as game playing and web browsing. In comparison to the PC they measure up poorly if at all. The consumer in most cases will not be satisfied with what these devices offer and thus the purchase of a PC is not eliminated. These device types each have limitations that prevent them from gaining wide acceptance by consumers as an acceptable standard. While each is different they overlap in areas and none gracefully converge the media types in a way that the consumer can gain the full benefit of the content and functionality available. Of these devices only the Home Theater Personal Computer enables open architecture and numerous choices of attached devices. Over the last year some new variations of functionality was added to the PC computer by some hardware and software companies in an effort to make it fit in the living room entertainment center. These efforts have failed to produce a widely adopted standard for interactive TV and media convergence.

Consequently, there is a present and future need to resolve this computer and media access device deficiency and deliver on the promise of the digital home.

### BRIEF DESCRIPTION OF THE DRAWINGS

All figures are general in nature and in accordance with one embodiment of the present invention.

FIG. 1 is an overview with 3 items; items 2 and 3 are an examples of one embodiment of the present invention.;

FIG. 2 is an overview of the remote unit with 3 items;

FIG. 3 is an overview of the physical connection to the PC/HTPC host computer and the transceiver unit;

FIG. 4 is a block diagram illustrating the transceiver unit functions; and

FIG. 5 is a block diagram illustrating the remote unit functions.

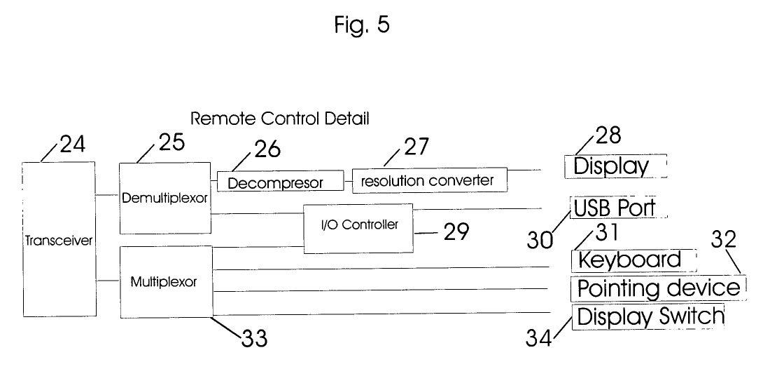

### SUMMARY OF CERTAIN EMBODYMENTS OF THE INVENTION

Thus, at least one embodiment of the present invention is to provide portability to the home PC and combine access to all media types within the home in a very convenient way. In essence the present invention removes all disadvantages that the HTPC has been plagued with from its inception and provides a means to enjoy and benefit from all media types throughout the home. This device enables the HTPC and frees consumers to make many choices as they deem suitable such as the operating system, software and hardware of preference as the standard PC has done in the past. The present invention could also provide a built in scan converter to accommodate the old analog equipment in a digital broadcast environment. The system could also be embedded in computer and set-top-box cases rather than the separate components presented herein. The device has the potential to create numerous opportunities for many businesses that provide related hardware and software. The tremendous interest in an interactive TV system and a new advertising and revenue model for broadcast media companies is inherent to the adoption of the current invention.

The new control and display system is needed for the HTPC to gracefully present the media types in a way that the consumer can gain the full benefit of the content and functionality available. While accomplishing the above the current invention also provides the basses for a whole new interactive TV system that is viable because it presents the interaction in a comfortable way for the consumer. The current interactive TV systems are not able to provide interaction without disruption of the content being viewed on a single display system.

### DETAILED DESCRIPTION OF CERTAIN EMBODYMENTS OF THE INVENTION

In one experimental example a system was setup with dual monitors. From this it was concluded that it would be desirable to place the menu system on a separate display and that display would also resolve the problem of displaying applications that were uncomfortable to work with on the large display. It was with the high speed wireless network evolution that the envisioned product could work. The Ultra Wide Band based chipsets available now provide the bandwidth needed to transmit data at transmission speeds up to 100 million bits per second (Mbps) and others such as 803.11 maybe implemented. This provides for the bandwidth to transport display and USB data at speeds needed to implement the current invention and provides for a very responsive system to user input and the added flexibility of the USB port offers. 1394 (FireWire) maybe implemented along with the described USB link.

In experimentation a problem with dragging a window with TV in it to the second display was noted and the concept of display swapping was envisioned as a way to overcome this. After these core concepts were thought out in detail, it became apparent that the whole concept had many positive implications beyond solving the problem at hand and development of an enhanced HTPC product. The concept enables a one entertainment and computing purchase concept for the consumer. The one computer could provide the large screen entertainment value and all standard PC uses in a portable way with out disruption to those viewing a movie. It was realized this was much more than a remote control for the HTPC. Another advantage is that the device would have little to go obsolete. Considering it is a wireless display, keyboard, and mouse it is not likely go obsolete as is the case with the CPU and hard disk. With the normal PC interface users don't need to learn to use a new device or operating system. The unit is also operating system independent so user choice is enhanced. This unit also has the potential to replace all remote controls for the entertainment system and could control home automation.

The disclosed embodiments relate to:

(a) to provide a base unit to support the wireless transmissions to and from the hand held remote display and control unit, hereinafter referred to as “Base Unit”. Said base unit provides for hard wired interconnects to the host computer unit for relay of data transmissions to and from hand held remote display and control unit. Said base unit can provide for spar battery charging implementation (optional);

(b) to provide a hand held remote display and control unit, hereinafter referred to as “Remote Unit”. Said Remote Unit sends and receives data transmissions to and from Base Unit and provides display swapping;

(c) to provide a charge unit that can provide for spar battery charging and direct connect to Remote Unit for charging the battery while in use;

(d) to provide for hard wired interconnects to the PC or HTPC for relay of data transmissions for the operation and wireless transmissions of,

1. Display

2. Keypad

3. Pointing device

4. USB Port;

Use as a consumer home electronics product is the intended use for certain examples of the present invention although potentially versions of it will be used in business markets.

In the preferred embodiment there is only the basic implementation to keep usage simple and the price low. This basic embodiment contains 2 main units and a battery charging unit. These main units are a transceiver unit and a remote control unit. The basic configuration routes the keyboard and pointer input from the remote control unit to the host computer and routes video output from the host computer to the remote control unit. As a general feature the USB port input and output routing is also provided and could be implemented as the sole link for all input and output if the keyboard and pointer are USB based devices. Some additional aspects that could be built in to the system are phone, video input, and audio.

The system as a whole is dependent on connection to a PC. It is a remote control and display for PC input and output. To the user this provides the essence of a portable computer but is in fact only a remote control. The system also provides for the host PC to output two video signals. These video outputs are controlled so one can be displayed on the remote unit while the other is passed through to the directly connected display. From the remote unit these displays can be exchanged. This display output swapping is provided through a switch on the remote unit or short cut key or key combination and could send the signals to the transceiver to swap the displays or to the host computer's video drivers.

The preferred configuration for the overall HTPC system is to have a large display attached that should be at least about 19 inch for viewing of movies, video, and anything that is suited to a large display. The remote control provides the small and close up display for other content. Some content will be suited to a particular display during certain times. As an example, if someone was using the remote control (small display) and had something on screen to share with the people in the room watching the large display, this could be accomplished by using the display swap function. This dual display system also provides for the menus to be displayed conveniently on the small display and the dual video system provides for practical interactive TV, enabling interaction without the disruption that a single display system would produce. On a dual display system the pointer is moved to and from displays by simply reaching the end of a display area. Once it has gone off the one screen it appears on the next screen.

The envisioned invention is quite simple in regard to the technology used in contrast to the over all ramifications that are very broad. The potential to set a standard for the digital home of the future and interactive TV is inherent to the concept. While the product is ready and able to be implemented today the hardware and software that could be developed to take full advantage of the system is vast. As an example a TV card maker could provide functionality specific to the described configuration. This could be the assignment of the TV window to be placed by default on a certain display while the menu defaults to the other display.

Detached menus on separate displays are desirable and this is available on many software products now. Existing security and home automation systems that are PC based would be ideal candidates for the system. The concept of a centralized point of control can be extended to the Internet through a login to access home automation and control from anywhere.

Other embodiments could include a built in video camera, relay of audio for communications and voice control. Although these options exist and are obvious they could also be implemented using the USB port. Thus to extend functionality manufactures could add USB devices and software drivers to provide desired functionality. Many existing devices and hardware could be conveniently used with the system now.

The preferred embodiment as intended is relying on sound from speakers connected to the PC and thus not implemented on the remote unit. The sound system is intended to be connected to the main home audio system. This provides HI FI quality for the audio downloaded to the PC or streaming in from any source.

An obvious extension to the overall concept would be to provide multiple key and pointer inputs through drivers at the operating system level. This combined with the multiple displays could be implemented with hardware to provide multiple remote controls. This functionality is not implemented in the present invention.

The present disclosed embodiment of the invention relate to a remote control for the heart of a digital home entertainment network appliance that is computer based or set-top-box based as no distinction between the two is realistically viable in the context of the future home entertainment and media gateway. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The present example of the invention may comprise an apparatus and method for effectively implementing a digital home entertainment network appliance remote control, and may preferably include a transceiver device and remote control device.

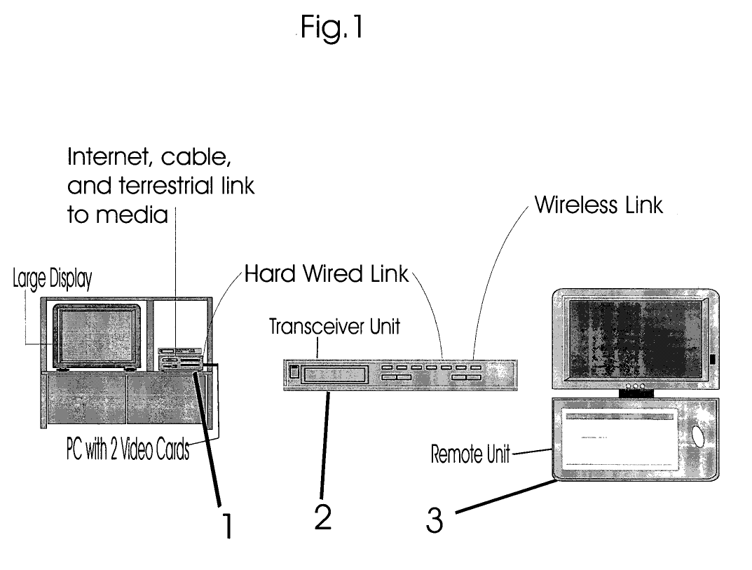

The preferred host computer is the PC/HTPC system configuration 1 for implementation of the remote control system and Transceiver Unit 2, hardwired to PC/HTPC 1 and connected to Remote Unit 3 to relay data signals in accordance with the present invention is shown in FIG. 1.

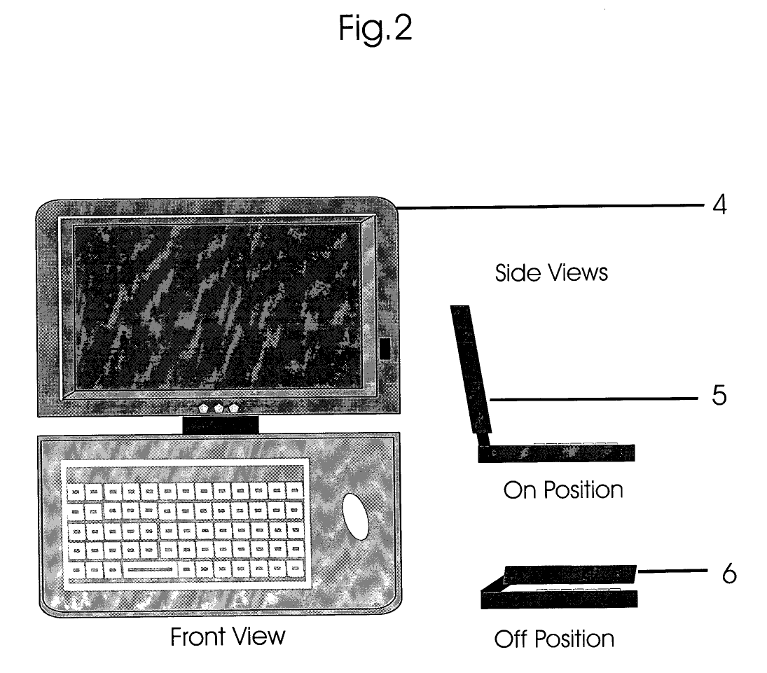

The preferred remote control configuration unit 4 is on when open 5 and turned off when closed 6 as shown in FIG. 2.

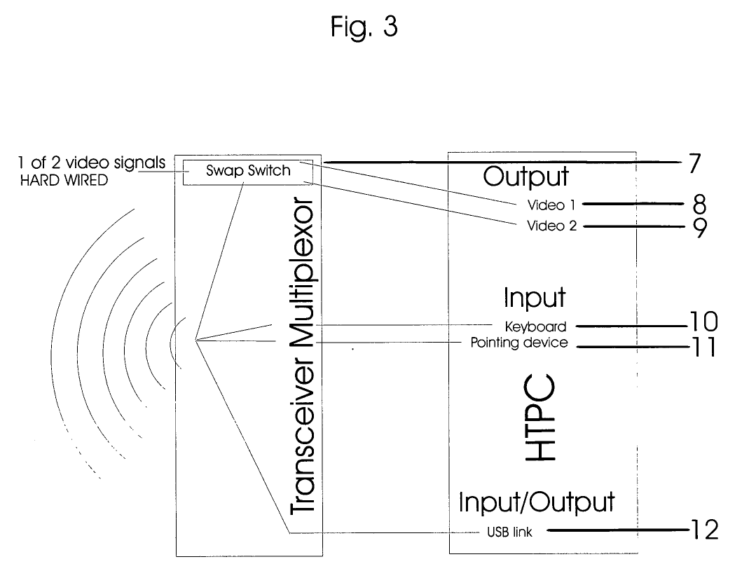

The video swap switch is housed in the transceiver 7 and controls the routing of video signals from the PC 8 and 9 to the remote control unit or passed through to the connected display. The keyboard data 10 and pointer data 11 is input to the PC. The USB link 12 provides for USB input and output as shown in FIG. 3.

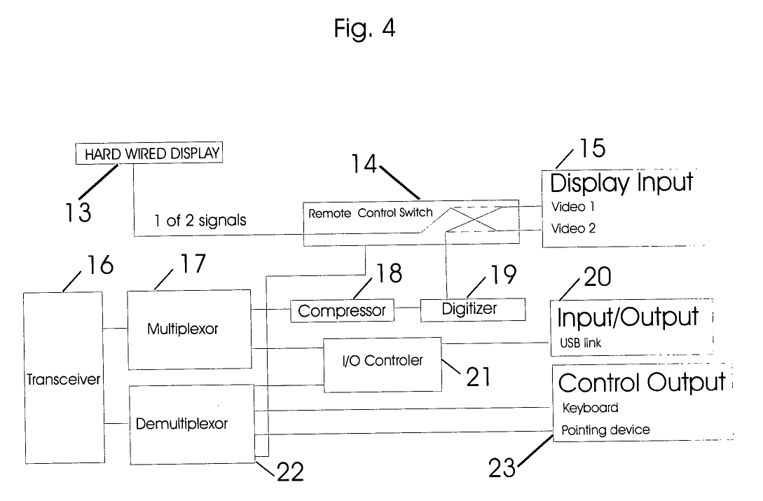

The large display 13 is hardwired to the transceiver for display of one of the two video outputs provided by the remote control switch 14 from the PC video signals 15 as controlled by a signal from the remote control unit passed through from the de-multiplexer 22. The transceiver 16 sends data to the remote unit from the multiplexer 17 and receives data from the remote unit that is forwarded to the de-multiplexer 22. The digitizer 19 detects data type and digitizes if needed before passing the data to the compressor 18 that compresses the data for efficiency before passing the data to the multiplexer 17. The USB data 20 from the PC USB port passes all input and output to the I/O controller 21 for routing to or from the de-multiplexer or multiplexer. Keyboard and pointing device data is passed to the input device ports 23 from the de-multiplexer 22 as shown in FIG. 4.

The transceiver 24 sends data to the PC attached transceiver unit from the multiplexer 33 and receives data from the PC attached transceiver unit that is forwarded to the de-multiplexer 25. The de-multiplexer 25 passes data to the de-compressor 26 or the I/O controller 29. Video data routed from the de-compressor 26 is sent to the video converter 27 that detects data type and converts to the format needed for the implemented flat panel display. The USB data 30 from the remote control unit USB port is passed to the I/O controller 29 for routing to and from the de-multiplexer 25 or multiplexer 33. The keyboard 31 and pointing device 32 data is forwarded to the multiplexer 33. A signal from the display switch 34 is forwarded to the multiplexer 33.

What is claimed is:

1. A remote and local display system for remote control and interaction by a user of a host computer system having dual video output ports comprising: a transceiver unit with two display input ports linking to the main computer video output ports for video signal routing to one of two displays, wherein one display is a wireless remote display on a remote control unit and the other is a hard wired display and the sources of video output to the two displays maybe swapped at the transceiver unit or at the host computer using video system drivers, said remote and local display system comprising:
a) a transceiver unit providing for the exchange of data with the host computer and the wireless remote display on a remote control unit;
b) a remote control unit having a transceiver and supporting circuits for operation of graphics display.

2. A remote and local display system for remote control and interaction by a user of a host computer system having dual video output ports comprising: a transceiver unit with two display input ports linking to the main computer video output ports for video signal routing to one of two displays, wherein one display is a wireless remote display on a remote control unit and the other is a hard wired display and the sources of video output to the two displays maybe swapped, said remote and local display system comprising:
a) a transceiver unit providing for the exchange of data with the host computer and the wireless remote display on a remote control unit;
b) a signal provided to the switching mechanism to swap both displays simultaneously contained in the transceiver unit that is triggered by remote operation or said switching mechanism maybe triggered directly on the host computer by video system drivers for software controlled video switching;
c) a remote control unit having a transceiver and supporting circuits for operation with, said remote control unit comprising:
i) a graphics display for presenting multimedia, video and data;
ii) a keypad input device;
iii) a pointing device;
iv) a display swapping switch.

3. A remote and local display system for remote control and interaction by a user of a host computer system having dual video output ports and a universal serial buss port comprising: a transceiver unit with two display input ports and a universal serial buss port that in turn links to the main computer video output ports for video signal routing to one of two displays and routing of universal serial buss input and output, wherein one display is a wireless remote display on a remote control unit and the other is a hard wired display and the sources of video output to the two displays maybe swapped and the universal serial buss input and output transmitted to and from the remote control unit, said remote and local display system comprising:
a) a transceiver unit providing for the exchange of data with the host computer and the wireless remote display on a remote control unit;
b) a signal provided to the switching mechanism to swap both displays simultaneously contained in the transceiver unit that is triggered by remote operation or said switching mechanism maybe directly controlled by signal to the host computer video system drivers for software controlled video switching;
c) a remote control unit having a transceiver and supporting circuits for operation with, said remote control unit comprising:
i) a graphics display for presenting multimedia, video and data;
ii) a keypad input device;
iii) a pointing device;
iv) a display swapping switch; and
v) a universal serial buss port.
